(19) United States
(12) Patent Application Publication
(10) Pub. No.: US 2019/0376460 A1
(43) Pub. Date: Dec. 12, 2019

(54) REMEDIAL ACTION FOR INVALID PARTICULATE FILTER SOOT

(71) Applicant: GM GLOBAL TECHNOLOGY OPERATIONS LLC, Detroit, MI (US)

(72) Inventors: Alexander Michel, Rheinbollen (DE); Simon Schiesser, Mainz (DE); Daniel Siebert, Mainz (DE); Rafat F. Hattar, Royal Oak, MI (US); Jochen Grieser, Seligenstadt (DE); Markus Kraft, Bad Camberg (DE)

(21) Appl. No.: 16/003,734

(22) Filed: Jun. 8, 2018

(51) Int. Cl. F02D 41/02; F01N 3/023; F02D 41/12

(52) U.S. Cl. CPC F02D 41/029; F01N 3/023; F02D 41/024; F02D 2200/1002; F02D 2200/0802; F02D 2200/0812; F02D 41/123

(57) ABSTRACT

Technical solutions described herein includes an exhaust system for treating exhaust gas from an internal combustion engine in a motor vehicle. The exhaust system includes a gas particulate filter, and a controller that controls soot loading estimation for the gas particulate filter. Controlling the soot loading estimation includes checking validity of soot loading estimation, and in response to the soot loading estimation being invalid, initiating a remedial action to limit soot deposition on the gas particulate filter. The remedial action includes determining a temperature at an inlet of the gas particulate filter, and if the temperature is within a predetermined range, inhibiting a deceleration fuel cut off of the internal combustion engine.

The present disclosure relates to exhaust systems for internal combustion engines, and more particularly to remedial action for invalid particulate filter soot mass estimation.

Gas particulate filters (GPFs) are designed to remove soot from the exhaust flow of an internal combustion engine. When the accumulated soot reaches a predetermined amount, the filter is “regenerated” by burning off the accumulated soot. Typically, mathematical and empirical soot models are used to estimate the amount of soot present in the GPF so that timely disposal or regeneration of the GPF can be performed. Modeling the exhaust flow and resultant GPF loading is dependent on complex chemical reactions and physical flow dynamics, the models utilizing multiple lookup tables and parameters, based on engine and vehicle testing and calibration work.

The GPF functions optimally when the amount of soot present is below a predetermined amount. An accurate soot model prediction ensures that the GPF is not regenerated unnecessarily at relatively low soot concentrations (grams of soot per volume of filter), thus enhancing fuel economy. Also, accurate soot model prediction ensures that the GPF is not regenerated when soot mass it too high to safely preform the regeneration.

### SUMMARY

Technical solutions described herein includes an exhaust system for treating exhaust gas from an internal combustion engine in a motor vehicle. The exhaust system includes a gas particulate filter, and a controller that controls soot loading estimation for the gas particulate filter. Controlling the soot loading estimation includes checking validity of soot loading estimation, and in response to the soot loading estimation being invalid, initiating a remedial action to limit soot deposition on the gas particulate filter. The remedial action includes determining a temperature at an inlet of the gas particulate filter, and if the temperature is within a predetermined range, inhibiting a deceleration fuel cut off of the internal combustion engine. The predetermined range is representative of a temperature range at which an uncontrolled burn of soot can occur at the gas particulate filter.

In one or more examples, the remedial action further includes, limiting engine torque generated by the internal combustion engine. Alternatively, or in addition, the remedial action further includes if the temperature is below a predetermined target value, triggering a warm-up of the gas particulate filter. The predetermined target value is representative of a temperature level at which soot oxidation occurs at the gas particulate filter.

Alternatively, or in addition, the remedial action further includes, if the temperature is at least a predetermined threshold, triggering a regeneration of the gas particulate filter. Further, the remedial action includes determining a number of miles since a previous regeneration of the gas particulate filter, and triggering the regeneration of the gas particulate filter if the number of miles is greater than a predetermined threshold.

According to one or more aspects, a method for controlling soot loading estimation for a gas particulate filter in a motor vehicle includes checking validity of soot loading estimation performed by a controller, the validity determined based on detection of a fault of a sensors. The method further includes, in response to the soot loading estimation being invalid, initiating a remedial action to limit soot deposition on the gas particulate filter. The remedial action includes determining a temperature at an inlet of the gas particulate filter, and, if the temperature is within a predetermined range, inhibiting a deceleration fuel cut off of an internal combustion engine.

In one or more examples, the remedial action further includes, limiting engine torque generated by the internal combustion engine. Alternatively, or in addition, the remedial action further includes if the temperature is below a predetermined target value, triggering a warm-up of the gas particulate filter. The predetermined target value is representative of a temperature level at which soot oxidation occurs at the gas particulate filter.

Alternatively, or in addition, the remedial action further includes, if the temperature is at least a predetermined threshold, triggering a regeneration of the gas particulate filter. Further, the remedial action includes determining a number of miles since a previous regeneration of the gas particulate filter, and triggering the regeneration of the gas particulate filter if the number of miles is greater than a predetermined threshold.

According to one or more aspects, a computer program product includes a memory storage device having computer executable instructions stored therein, the computer executable instructions when executed by a processor cause the processor to execute a computer-implemented method for a remedial action for invalid particulate filter soot in an exhaust system in a vehicle. The method includes checking validity of soot loading estimation performed by a controller, the validity determined based on detection of a fault of a sensors. The method further includes, in response to the soot loading estimation being invalid, initiating a remedial action to limit soot deposition on the gas particulate filter. The remedial action includes determining a temperature at an inlet of the gas particulate filter, and, if the temperature is within a predetermined range, inhibiting a deceleration fuel cut off of an internal combustion engine.

In one or more examples, the remedial action further includes, limiting engine torque generated by the internal combustion engine. Alternatively, or in addition, the remedial action further includes if the temperature is below a predetermined target value, triggering a warm-up of the gas particulate filter. The predetermined target value is representative of a temperature level at which soot oxidation occurs at the gas particulate filter.

Alternatively, or in addition, the remedial action further includes, if the temperature is at least a predetermined threshold, triggering a regeneration of the gas particulate filter. Further, the remedial action includes determining a number of miles since a previous regeneration of the gas particulate filter, and triggering the regeneration of the gas particulate filter if the number of miles is greater than a predetermined threshold.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a generalized illustration of an engine and an associated exhaust system that is configured to treat the exhaust flow produced by the engine; and

FIG. 2 depicts a flowchart of an example method for performing a remedial action for invalid particulate filter soot mass deposit estimation.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory module that executes one or more software or firmware programs, a combinational logic circuit, and/or other suitable components that provide the described functionality.

Treatment of exhaust gas from a combustion engine such as a gasoline engine involves various exhaust component catalytic converters (closed coupled and underfloor) having one or more catalysts disposed on a substrate for reducing the levels of regulated constituents in gasoline exhaust. For example, gasoline exhaust treatment systems may include a close coupled and underfloor converters that convert HC and CO to CO2, as well as a gas particulate filter (GPF) for removal of particulates. In some instances, the catalyst converter is combined with the GPF into a single unit usually referred to as a single volume coated filter (SVcF).

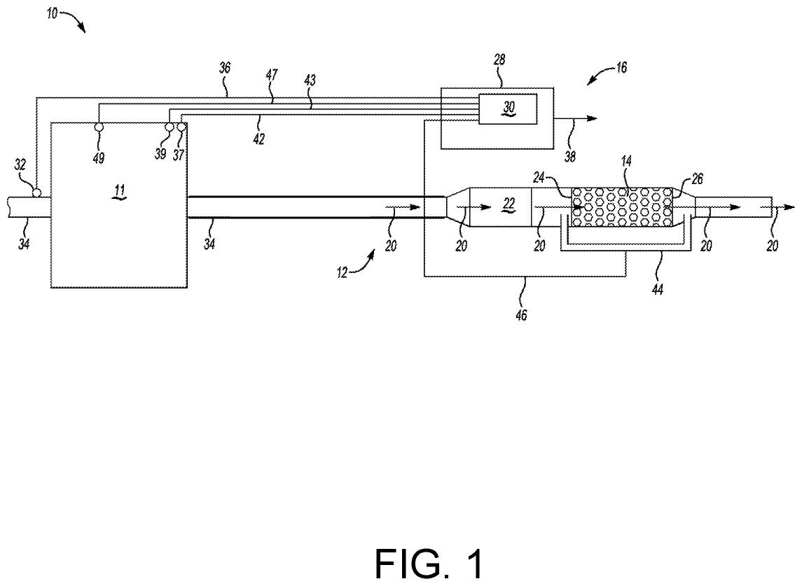

FIG. 1 shows a vehicle 10 that includes an engine 11 with a representative exhaust system 12 that includes a GPF 14. A monitoring system 16 for the GPF 14 is operable to monitor the amount of soot mass in the GPF 14 in order to ensure filter performance, enhance overall fuel economy and reduction of emissions, and provide for timely regeneration of the GPF 14. It should be noted that although the embodiments herein describe a gasoline engine, the technical solutions described herein can be used for a diesel engine in one or more examples.

The exhaust system 12 includes a catalytic converter 22 that oxidizes and burns hydrocarbons in the exhaust flow 20 exiting the engine 11. Exhaust then flows from an inlet 24 of the GPF 14 to an outlet 26 of the GPF 14, and exits the exhaust system 12. The exhaust system 12 is a single volume coated filter, however in other examples the exhaust system 12 may instead be arranged as a single volume uncoated filter (SVuF) or an underfloor GPF.

The monitoring system 16 includes a controller 28 that has a processor 30 that executes stored algorithms from a tangible, non-transitory memory, for example, to estimate the amount of soot in the GPF 14 and, based on the estimate, outputs a control signal 38 when regeneration of the GPF 14 is warranted, to thereby cause engine operation at conditions (such as increased fuel amount) that initiate regeneration of the GPF 14. If the GPF 14 is a type that is actively regenerated by changing operating parameters to increase exhaust flow temperature to burn the soot, the signal 38 may affect engine parameters to cause the increase in temperature of the exhaust flow 20.

Measurements reflecting real-time operating parameters in the exhaust system 12 are input into the controller 28. For example, the monitoring system 16 may include an engine speed sensor 32 positioned in operative communication with the engine crankshaft 34 and operable to monitor engine speed 36 such as in revolutions per minute (rpm) and provide a signal representing engine speed to the processor 30. Additionally, the monitoring system 16 includes a sensor 37 that measures air fuel ratio in the engine 11 and provides an air fuel ratio 42 via a signal to the processor 30. The monitoring system 16 also includes a sensor 39 that measures air flow into the engine 11 and provides an air flow measurement 43 via a signal to the controller 28. A fuel flow measuring device 49 measures an injected fuel quantity rate 47 such as the fuel flow in cubic millimeters per engine stroke (mm³/cycle) into a fuel injection system for the engine 11. The fuel quantity rate 47 is provided as a signal to the processor 30. Fuel quantity rate 47 is proportional to engine load (e.g., torque at the crankshaft 34). Additional vehicle operating conditions, such as additional engine operating parameters and exhaust system 12 operating parameters can also be provided to the controller 28. For example, exhaust temperature and other parameters can be monitored.

The monitoring system 16 also includes a differential pressure measurement device 44 that is operable to measure a third operating parameter, which is a pressure differential between exhaust flow at the inlet 24 and exhaust flow at the outlet 26 of the GPF 14. The differential pressure measurement device 44 is in fluid communication with the exhaust flow 20 at the inlet 24 and at the outlet 26 and emits a signal representative of a differential pressure 46 (also referred to as a pressure drop). The differential pressure 46 is utilized by the processor 30 as further described herein.

A technical challenge with estimating the soot load on the GPF 14 and performing a regeneration is that the when soot loading determination is not feasible, the soot deposited on the GPF 14 can cause GPF clogging or over temperature in the exhaust system 12. The GPF clogging can cause damage to the GPF 14 itself, as well as other components in the exhaust system 12 or the vehicle 10. Further, a failure in the soot estimation can cause excess temperatures and oxygen in the exhaust system 12, which can also cause damage to the components in the exhaust system 12/vehicle 10. The technical solutions described herein address such technical challenges by minimizing the clogging or damaging of the GPF 14 from an uncontrolled burn when soot loading determination is not feasible based on control/parameter measurements, and further facilitate eliminating excess temperatures and oxygen in the exhaust system 12.

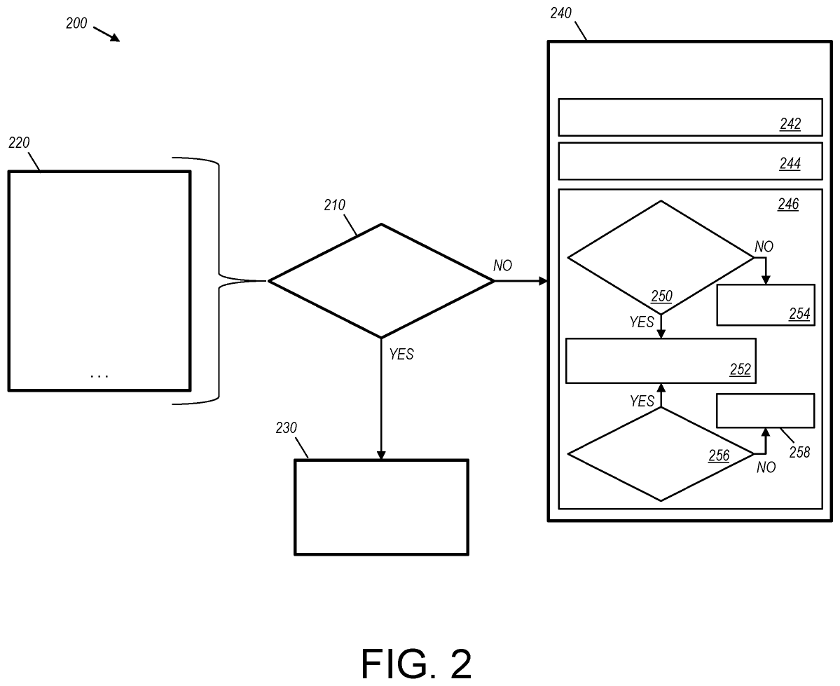

FIG. 2 depicts a flowchart of an example method 200 for performing a remedial action for invalid particulate filter soot in the exhaust system 12. The method includes determining if soot loading determination is not feasible, at 210. In other words, the method includes determining if the soot load estimation is valid. The validity/feasibility of the soot loading determination is determined by detecting operability of one or more components, at 220. For example, if an exhaust gas temperature (EGT) sensor failure is detected, the soot loading estimation is invalid/infeasible. Further, if a differential pressure sensor (DPS) failure is detected, such as at the differential pressure measurement device 44, the soot loading estimation is invalid/infeasible. Further, the method includes detecting a fault in the exhaust flow 20, such as based on the air flow measurements from the air flow sensor 39 and/or the air fuel ratio 42. In case of a fault detected in the exhaust flow 20, the soot loading estimation is invalid/infeasible. Additionally, or alternatively, in case exhaust system icing is detected, for example, using the EGT sensor, the soot loading estimation is invalid/infeasible. Further yet, in case a failure is detected with the soot estimating model being used, the soot loading estimation is invalid/infeasible.

The failure detection in the one or more components described herein can be performed using one or more known techniques. For example, error detection is performed by comparing sensor/device output with a redundant/backup sensor/device. Alternatively, or in addition, the one or more measurements are compared with corresponding estimated values that are computed using a mathematical model. In yet other cases, a fault is detected if the measured or estimated values are beyond predetermined ranges in which the components of the vehicle 10 are configured to work.

It should be noted that the soot loading estimation validity/flexibility detection can be based on failure/condition detected with other components than the examples described above.

Further, if the soot loading estimation is determined to be valid/feasible, for example, a component failure is not detected, the method includes continuing with GPF regenerations based on the soot loading estimation, at 230. The GPF regeneration, as described herein, can be performed once the estimated soot load goes above a predetermined threshold, taking into consideration other factors such as exhaust gas temperature, and so on.

If the soot loading estimation is determined to be invalid/infeasible, for example, a component failure is detected, the method includes performing one or more remedial actions to reduce the risk of clogging or thermal damaging the GPF 14, at 240. The remedial action(s) are control measures taken to eliminate excess temperatures and oxygen in the exhaust system 12.

The remedial action includes limiting engine torque to reduce soot accumulation, at 242. Such an action does not provide component protection directly, but facilitates lower soot emissions at lower load. Further, limiting the engine torque can increase a driver's perception for the need to service the vehicle 10, where the one or more errors in the soot loading estimation can be further diagnosed and possibly repaired.

The remedial action can include inhibiting deceleration fuel cut off (DFCO), at 244. In one or more examples, the DFCO is inhibited if temperature at the inlet 24 of the GPF 14 is above a predetermined range. For example, the predetermined temperature range checked is where uncontrolled burn can occur.

Alternatively, or in addition, the remedial action includes performing a soot-burning, at 246. Performing the soot-burning includes first checking if the temperature at the inlet 24 of the GPF 14 is greater than a predetermined target value, which is a predetermined threshold, at 250. If the temperature at the inlet 24 of the GPF 14 is greater than (or equal to) the target, the controller 28 triggers a soot-burning as part of a limited regeneration of the GPF 14, at 252. In one or more examples, as part of the limited regeneration of the GPF 14, the controller 28 controls an equivalence ratio (EQR) of the air fuel mixture combusted by the engine 11. For example, the controller 28 may control the EQR based on a stoichiometric EQR during normal engine operation. For the limited regeneration of the GPF 14, the controller 28 adjusts the EQR to a lean EQR (i.e., EQR<stoichiometric EQR). The controller 28 adjusts the EQR to the lean EQR by reducing the amount of fuel being injected while decreasing or, increasing the amount of air into the engine 11. For example, the controller 28 increases at least one engine airflow parameter (e.g., throttle opening) and retards spark timing when adjusting the EQR to the lean EQR. In one or more examples, the target temperature value is a calibrateable value and is representative of a temperature for soot oxidation from the GPF 14. The lean EQR is also a calibrateable value.

The limited regeneration of the GPF 14 further includes checking a mileage of the vehicle 10 when the limited regeneration is triggered, at 256. In one or more examples, the limited regeneration is performed only if the number of miles traveled by the vehicle 10 since a previous regeneration exceeds a predetermined threshold, at 252. If the mileage condition is not satisfied, the controller 28 performs remedial action(s) other than the limited regeneration of the GPF 14, at 258.

Alternatively, if the temperature at the inlet 24 of the GPF 14 is lesser than (or equal to) the target, the controller 28 triggers GPF warm-up actions, at 254. For example, warm up phase of the engine parameters like spark, cam phasers, idle engine speed, fuel injection and fuel timing are adjusted to achieve the target soot burring temperature at the inlet 24 of the GPF 14, the combustion charge is used to increase the exhaust temperature instead of being used to perform work (i.e. generate power/torque by the engine). In one or more examples, a cam phasers are controlled to minimum MAP (Manifold Pressure) allowing high load on the engine resulting in high exhaust flow and faster regen duration. Spark is retarded in conjunction with multiple pulse and injection timing facilitating more aggressive spark retard while maintaining combustion stability for faster head release into the exhaust 20.

Accordingly, the technical solutions described herein facilitate performing remedial actions once the soot loading is indeterminate and the mileage since last regeneration exceeds a predetermined threshold value. The technical solutions described herein accordingly facilitate minimizing a risk of clogging or damaging the GPF 14 from uncontrolled burn when soot loading determination is not feasible using control measures to eliminate excess temperatures and oxygen in the exhaust system 12. The technical solutions described herein improve performance of the exhaust system 12 and the vehicle 10 in turn.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An exhaust system for treating exhaust gas from an internal combustion engine in a motor vehicle, the exhaust system comprising:
a gas particulate filter; and
a controller configured to control soot loading estimation for the gas particulate filter, controlling the soot loading estimation comprising:
checking validity of soot loading estimation;
in response to the soot loading estimation being invalid, initiating a remedial action to limit soot deposition on the gas particulate filter, the remedial action comprising:
determining a temperature at an inlet of the gas particulate filter; and
if the temperature is within a predetermined range, inhibiting a deceleration fuel cut off of the internal combustion engine.

2. The exhaust system of claim 1, wherein the predetermined range is representative of a temperature range at which an uncontrolled burn of soot can occur in the gas particulate filter.

3. The exhaust system of claim 1, wherein the remedial action further comprises, limiting engine torque generated by the internal combustion engine.

4. The exhaust system of claim 1, wherein the remedial action further comprises, if the temperature is below a predetermined target value, triggering a warm-up of the gas particulate filter.

5. The exhaust system of claim 4, wherein the predetermined target value is representative of a temperature level at which soot oxidation occurs at the gas particulate filter.

6. The exhaust system of claim 1, wherein the remedial action further comprises if the temperature is at least a predetermined threshold, triggering a regeneration of the gas particulate filter.

7. The exhaust system of claim 6, further comprising, determining a number of miles since a previous regeneration of the gas particulate filter, and triggering the regeneration of the gas particulate filter if the number of miles is greater than a predetermined threshold.

8. A method for controlling soot loading estimation for a gas particulate filter in a motor vehicle, the method comprising:
checking validity of soot loading estimation performed by a controller, the validity determined based on detection of a fault of a sensor;
in response to the soot loading estimation being invalid, initiating a remedial action to limit soot deposition on the gas particulate filter, the remedial action comprising:
determining a temperature at an inlet of the gas particulate filter; and
if the temperature is within a predetermined range, inhibiting a deceleration fuel cut off of an internal combustion engine.

9. The method of claim 8, wherein the predetermined range is representative of a temperature range at which an uncontrolled burn of soot can occur at the gas particulate filter.

10. The method of claim 8, wherein the remedial action further comprises, limiting engine torque generated by the internal combustion engine.

11. The method of claim 8, wherein the remedial action further comprises, if the temperature is below a predetermined target value, triggering a warm-up of the gas particulate filter.

12. The method of claim 11, wherein the predetermined target value is representative of a temperature level at which soot oxidation occurs at the gas particulate filter.

13. The method of claim 8, wherein the remedial action further comprises, if the temperature is at least a predetermined threshold, triggering a regeneration of the gas particulate filter.

14. The method of claim 8, further comprises, determining a number of miles since a previous regeneration of the gas particulate filter, and triggering the regeneration of the gas particulate filter if the number of miles is greater than a predetermined threshold.

15. A computer program product comprising a memory storage device having computer executable instructions stored therein, the computer executable instructions when executed by a processor causes the processor to execute a computer-implemented method for a remedial action for invalid particulate filter soot in an exhaust system in a vehicle, the method comprising:
checking validity of soot loading estimation for a gas particulate filter, the soot loading estimation performed by a controller, the validity determined based on detection of a fault of a sensor; and
in response to the soot loading estimation being invalid, initiating a remedial action to limit soot deposition on the gas particulate filter, the remedial action comprising:
determining a temperature at an inlet of the gas particulate filter; and
if the temperature is within a predetermined range, inhibiting a deceleration fuel cut off of an internal combustion engine.

16. The computer program product of claim 15, wherein the predetermined range is representative of a temperature range at which an uncontrolled burn of soot can occur at the gas particulate filter.

17. The computer program product of claim 15, wherein the remedial action further comprises, limiting engine torque generated by the internal combustion engine.

18. The computer program product of claim 15, wherein the remedial action further comprises, if the temperature is below a predetermined target value, triggering a warm-up of the gas particulate filter, the predetermined target value is representative of a temperature level at which soot oxidation occurs at the gas particulate filter.

19. The computer program product of claim 15, wherein the remedial action further comprises, if the temperature is at least a predetermined threshold, triggering a regeneration of the gas particulate filter.

20. The computer program product of claim 15, wherein the method further comprises, determining a number of miles since a previous regeneration of the gas particulate filter, and triggering the regeneration of the gas particulate filter if the number of miles is greater than a predetermined threshold.
